(19) United States
(12) Patent Application Publication
(10) Pub. No.: US 2015/0190662 A1
(43) Pub. Date: Jul. 9, 2015

(54) INDUSTRIAL EDS (EMERGENCY DESCENT SYSTEM) HARNESS

(71) Applicant: Norman E. Wood, Cameron, WV (US)

(72) Inventor: Norman E. Wood, Cameron, WV (US)

(21) Appl. No.: 14/571,242

(22) Filed: Dec. 15, 2014

Related U.S. Application Data
(60) Provisional application No. 61/916,267, filed on Dec. 15, 2013.

(51) Int. Cl. A62B 35/00

(52) U.S. Cl. CPC A62B 35/0006; A62B 35/0037; A62B 35/0043

(57) ABSTRACT

An industrial safety harness for allowing a distressed worker to lower him or herself from a distance at least six feet above ground. The harness comprises adjustable belt sections for the worker's upper chest, waist and upper thighs. In a grommet strap on the left shoulder of this harness, there is stored a brake pin guide and shortened brake pin and secondary brake strap. A triangular shaped panel for the worker's back holds a smaller diameter, lighter weight safety line, at least about 40 feet in length. One preferred line, made from Aramid®, passes through a modified delta cross brake that includes a Kevlar® component with a brake line guide that prevents line twisting. The improved brake applies frictional pressure from different directions at the same time.

### CROSS-REFERENCE TO RELATED APPLICATION

This application is a perfection of Provisional Patent Application Ser. No. 61/916,267, filed on Dec. 15, 2013, the disclosure of which is fully incorporated by reference herein.

### BACKGROUND OF THE INVENTION

1. Field of the Invention

The present invention relates to an emergency descent system, or “EDS” for use by anyone in a business context, including but not limited to those working in construction, utility operations, etc. The Federal Occupation Safety & Health Administration (or “OSHA”) requires that anyone working at a minimum height of 6 feet in any type of business wear a fall arrest system (or “FAS”). This harness will be worn in that setting. More particularly, this invention relates to an EDS that can be worn as a normal safety harness over clothing. Alternately, it can be integrated into a worker's clothing and/or coveralls, etc.

2. Relevant Art

Descent control devices have been developed with the objective of lowering individuals (or objects) from a higher to lower elevation. Such devices have taken many forms and have utilized a variety of elements. Some are capable of providing a mechanical braking mechanism, such as a dead-man or panic control feature, when the device would be used for descent, escape, or rescue purposes.

Concerns with occupational safety have led to the development of mechanisms that enable a worker to lower himself from an elevated position such as a scaffold, crane, lift truck or platform in the event of an emergency. That equipment is, in some respects, similar to known fire escape devices, mountain climbing equipment, and military equipment.

One descent control device with a dead-man brake, in the form of a vertical cylindrical drum or capstan about which a rope is wound and a tapered slot through the drum for receiving and releasably gripping the rope, is shown in Varner et al. U.S. Pat. No. 4,883,146. That device includes plates on each end of a vertical cylindrical drum or capstan with apertures on each end plate through which the rope is threaded, then wound in two or more turns around the drum.

Tapered slots are well known for releasably fastening ropes, lines and cables. The use of cylindrical capstans for holding and providing a mechanical advantage for tightening ropes is also known. Likewise, a variety of fire escape devices utilize rope wound around a cylinder. See, for example, Budd U.S. Pat. No. 386,237; FitzGerald U.S. Pat. No. 536,866; Howe U.S. Pat. No. 771,251; Thuemer U.S. Pat. No. 946,588; Smith U.S. Pat. No. 1,115,603; Steffen U.S. Pat. No. 4,311,218; and Forrest U.S. Pat. Nos. 4,508,193 and 4,550,801.

In addition, there are known but clearly distinguishable teachings in Hobbs U.S. Pat. No. 3,678,543; Arancio U.S. Pat. No. 3,738,449; Wagner U.S. Pat. No. 4,019,609; Bell et al. U.S. Pat. No. 4,714,135; Varner et al. U.S. Pat. Nos. 5,038,888 and 5,131,491; Bassett U.S. Pat. No. 6,131,697; Harbers Jr. U.S. Pat. No. 6,585,082; Metz U.S. Pat. No. 6,817,443; Henson U.S. Pat. No. 6,823,966; and Halevy U.S. Pat. No. 7,357,224. See also, Ador Published U.S. App. No. 20020112916; Price Published U.S. App. No. 20020158098; Gelman Published U.S. App. No. 20030159887; Richardson Published U.S. App. No. 20040140152; Fischer et al. Published U.S. App. No. 20060011415; Harris Jr. Published U.S. App. Nos. 20060113147 and 20100122874; Moon et al Published U.S. App. No. 20070158139; and Botti Published U.S. App. No. 200702460298.

### SUMMARY OF THE INVENTION

It is the principal object of the present invention to provide an improved controlled descent system that can provide full body protection to any and all workers operating at high levels in an industrial (commercial, construction, utility or other service) setting. While primarily intended as an outerwear item, it is understood that alternative embodiments may be BUILT INTO the clothing/coveralls, etc. worn by many service personnel.

A related object is to provide an industrial EDS-type harness (to be worn over an individual/wearer's chest and upper legs) for enabling that industrial user to affect a fail-safe descent from most any elevated working level in an emergency.

There are several key distinct differences/improvement of this harness over its original patent pending harness predecessors. Most notably:

1—A Brake Pin Guide and SHORTENED Brake Pin have been moved to the left side of the EDS Rack for this latest generation harness. This solves several problems. Particularly, it removes the pin from being atop the wearer's right shoulder when pulled. In the original harness designs, that location caused the pin to pull very hard and possibly stick in a sharp turn area of the shoulder strap while a person is suspended. That, in turn, caused the Brake Strap underneath in the Brake Plate Tunnel to be pinched and not move as freely. Moving the Brake Pin Guide from the end of the Brake Plate to the Brake Pin Grommet Strap on the left side of the EDS Rack allows for not only relocating the Brake Pin but also shortening its length. Now when the Brake Strap is pulled, the Brake Pin is pulled to underneath the EDS Rack and not up into the Right Shoulder Strap eliminating the possibility of Brake Strap jamming.

2—A serpentine Kevlar® Lined Brake and Limiter have been removed. This type of brake cannot be used on smaller diameter line, such as the 3/16″ line described herein. There is not enough surface area to allow the “earlier version” of brake to work. It puts a large amount of “twist” in the line that might cause it to jam within the EDS rack.

3—A Kevlar® Delta Cross Brake is used.

A—This brake is specifically designed for the smaller diameter lines like the preferred 3/16″ soft Aramid® lines described below.

B—It has a Brake Line Guide that prevents twists being made in the Line.

C—When the Kevlar® Delta Cross Brake is pulled on, it not only keeps the Line from twisting but it also applies frictional pressure from two different directions at the same time.

D—It causes the Line to bend, exerting even more frictional pressure.

E—This Brake is also OFFSET with the Left Arm longer than the Right and the Brake Anchor Strap is attached in such a way to allow for the Brake to PIVOT. When the Brake Strap is pulled, it applies pressure to the Brake and all of the stopping qualities are used. When pressure is reduced on that Brake Strap, the Kevlar® Delta Cross Brake relaxes. That causes it to straighten out and Pivot to the left or counter clockwise thereby allowing for the Line to more freely transverse through the Kevlar® Delta Cross Brake and up through the EDS Rack while the wearer descends.

When this new Brake Strap is pulled, it causes the Kevlar® Delta Brake Strap to do all of the following at the same time:

i—Rotate Clockwise;

ii—Start bending into a U configuration;

iii—Apply pressure to the Line from two different directions; and

iv—Squeeze Line over its complete 360° surface area over a 3″ long section.

F—the new Brake Line Guide prevents the Line from twisting during braking

All of these qualities are vital to insure proper braking when using such a small diameter soft Line.

4—a new size/shape of EDS Rack can now be used which is 50% smaller than the CDS Rack used in the original harness. This can be reduced in size for the smaller diameter Line used, 3/16″ line compared to the 11 mm (½″) line used in the Original Rescue One CDS Harness. This makes the harness lighter weight, less bulky and more compactable all of which results in greater comfort to the harness wearer of this invention.

5—Smaller Diameter Line, 3/16″ Aramid® Line. This new technology allows for a very small diameter, very lightweight (1.3 pounds per 100 feet), very strong (over 5000 pound tensile) very soft braided, compactable descent line that is also cut and burn resistant. All of these qualities result in a very light, compactable, comfortable harness with even greater line length carrying capacity, even greater descending ability and far better rescue potential for a greater number of industrial job applications including but not limited to the greater heights required of radio and microwave tower workers and those performing elevated wind turbine servicing.

Wind turbines are close to 300 feet in elevation. The amount of 11 mm line used in current rescue equipment to allow a worker to descend this distance will weigh in excess of 20 pounds and take up the space of a medium sized duffle bag. The amount of a 3/16″ Aramid Line needed to descend 300 feet weighs 3.9 pounds and can fit in a standard oatmeal box or small rope bag.

To recap: the Kevlar® Delta Cross Brake is key. It allows for the use of a smaller diameter line. With the smaller line, the size of EDS Rack can be correspondingly reduced. The technology of lines has improved to where a very small diameter line is also strong enough to be used in critical emergency escape and rescue applications. With the smaller and lighter components, it allows for the harness to be lighter, less bulky, and more comfortable. All of these qualities ensure that a worker will find less to dislike about the new harness, more to like and more of a reason to wear it which means more use, greater safety and more lives saved.

Lastly, the movement of the Brake Pin Guide and Brake Pin allows for the harness to operate more effectively.

### SUMMARY OF THE DRAWINGS

Further features, objects and advantages will become clearer when reviewing the detailed description made with reference to the accompanying drawings in which:

FIG. 1 is a top plan view of one embodiment of a finished waist belt according to this invention;

FIG. 2 is a top plan view of the suspension relief strap (SRS) and waist belt sewn thereto;

FIG. 3 is a close up view of the right side to an elastic support panel showing the line support loops joined adjacent one another;

FIG. 4 is a top plan view showing both angled side support panels between the side and center panels directly above the top edge of the waist belt;

FIG. 5 is a top plan view showing the Kevlar EDS Rack, and its top support straps glued to the middle Y brace;

FIG. 6 shows the same arrangement from FIG. 5 but with the Right Shoulder Strap affixed thereto;

FIG. 7 is a top plan view showing (dimensionally with a tape measure added) one embodiment of brake strap component;

FIG. 8 is a top plan schematic view for a Kevlar Delta Cross Brake according to this invention;

FIG. 9 is a top view showing the folded and sewn brake guide for the Kevlar Delta Cross Brake (KDCB);

FIG. 10 is a top plan view showing the Brake Anchor Strap folded over the Brake and Brake Guide Kevlar Delta Cross Brake;

FIGS. 11-13 show, sequentially, the Brake Guide Ends being folded backward and then hot melt glued to the Brake Anchor Strap;

FIG. 14 is a top view showing the lower section of the Brake Anchor Strap being folded up and over an upper section of that same Brake Anchor Strap;

FIG. 15 is a top view showing the Center Sewn area being centered on the Brake Anchor Strap fold;

FIG. 16 is a top plan view of a finished (fully assembled) Kevlar Delta Cross Brake (KDCB);

FIGS. 17 and 18 show the top (17) and bottom (18) views of the Brake Strap extending down to the top of the Delta opening;

FIG. 19 shows the tip of the Kevlar Delta Cross Brake pointed towards the center of the Brake Plate Opening;

FIG. 20 is a close up view showing the Kevlar Brake Pin Grommet Strap facing down next to and parallel with a left edge of the harness;

FIG. 21 is a top view showing the Brake Strap pulled through the Brake Plate Tunnel;

FIG. 22 is a top view showing the EDSRAS placed through the large bottom hole of the EDS Rack with a folded edge toward the middle of that EDS Rack;

FIGS. 23 and 24 show the front (23) and rear (24 views of one embodiment of brake strap cover (BSC) according to this invention;

FIG. 25 is a top plan view of one embodiment of brake pin for use with the present invention;

FIG. 26 is a top plan view showing one matching safety buckle and metal slider adjusting buckle for a leg strap component of this harness;

FIG. 27 is a top view showing the Tri Glide Adjusters of both Shoulder Straps placed through the same side of a Waist Belt Loop;

FIG. 28 shows a loop of Technora® line threaded through an Anchor Strap Loop then through itself;

FIG. 29 is a top view showing the Technora® line threaded back and forth between the elastic line holders, then the Kevlar Delta Cross Brake and EDS Rack;

FIG. 30 shows a template for cutting out a Tear-Away D-Ring Cover (TADRC) according to one embodiment of this invention;

FIG. 31 shows, in side view, a D-Ring Strap hot melt glued through a D-Ring according to this invention;

FIG. 32 is a top view showing Line 5″ End Loop fed through a D-Ring Strap Loop and the complete TADRSC, then secured to the D-R Strap Loop;

FIG. 33 is a close up view showing the SRS folded back and forth before being stored in its elastic storage panels in order to be deployed from the top layer down if/when needed;

FIG. 34 is a top plan view showing one preferred embodiment of line threading through a secured EDS Rack according to the invention;

FIG. 35 is a top view showing a Brake Strap Loop folded down onto its own Velcro component;

FIG. 36 shows the folded Brake Strap Loop of FIG. 35 stored its own Brake Strap Cover;

FIG. 37 is a close up view showing Line pulled up through the Kevlar Line Loop Guide and D-Ring;

FIG. 38 is a close up showing how during line installation, two loops are made on each side of the D-Ring with line coming from the Elastic Storage Loops;

FIG. 39 shows a pair of scissors holding the “spot” through which the Brake Pin will be insert in the direction of the scissors with the lower line loop coming over the top of the D-Ring and on the inside of the upper loop;

FIG. 40 is a close up view showing the Brake Pin inserted first through the Brake Pin Guide, next through the two created loops in the same direction as the scissors/place holder in FIG. 39, and then through the Kevlar Brake Pin Grommet Strap;

FIG. 41 is a close up showing the pin shoved through the 1″ D-Ring as far as it will go;

FIG. 42 is a top view showing the remaining Brake Pin Strap folded onto the Brake Plate near the EDS Rack;

FIGS. 43 and 44 are close up views showing the Brake Pin Strap Cover folded over the Brake Pin Strap and attached with its Velcro, its notched section going under the EDS Rack and attaching to its Brake Pin Strap Cover Security Strip;

FIGS. 45 and 46 are top views showing the harness before (45) and after (46) the Back Cover and Tear-Away D-Ring Cover are fully situated in place; and

FIG. 47 is a top plan, rear view of a fully assembled harness according to the present invention.

### DETAILED DESCRIPTION OF PREFERRED EMBODIMENTS

With reference to the accompanying drawings, there is shown a first preferred embodiment of Industrial EDS Harness. Also, When referring to any numerical length, width or other number range herein, it should be noted that all such numbers are mostly representative of just one embodiment of Industrial EDS harness (mostly as shown). Furthermore, any such range of numbers should expressly include each and every fraction or decimal between its stated minimum and maximum. For instance, any one component (strap, etc.) measuring from 1 to 3 inches in length should also specifically cover any strap measuring 1.1, 1.25 and 1.5 inches . . . and so on, up to about 2.75, 2.8 and 2.99 inches. The same applies for every other quantitative range herein.

The basic single layer harness will contain 44 feet of line as measured to a typical wearer's waist. Most people have another 3 feet of legs and with a tether of 4 to 6 feet for enabling easily descents of about 50 feet. In alternative versions, the line can be double or triple stacked with each additional layer increasing descent capability another 44 feet, all beneath a harness cover.

Still other variations employ an external line storage bag that can be attached to the rear of a harness for its wearer to descend several hundred feet if working on a Wind Turbine or other high elevation locale. When an external line storage bag is used, there will be no need to store a first section of line in elastic storage loops. All the line will be in the external storage bag and the line fed through an opening in the back of the harness and then transitioning through the Delta Cross Brake and up through the EDS Rack.

Note the following example for a working Industrial EDS Harness prototype:

### Components for Industrial EDS Harness

A—1⅞″ 6000 lb. nylon webbing (can be changed depending on application), approx. 40′.
   1—72″ Right Shoulder Strap (RSS)
   1—71″ Left Shoulder Strap (LSS) (Right will shorten due to sewing on Brake Plate later)
   2—Left 8″ and Right-26″ Chest Straps (CS)
   2—14½″ Line Loop Braces (LLB)
   2—14½″ Elastic Loop Braces (ELB)
   2—5″ Elastic Loop Brace Bridge Strap (ELBBS)
   1—6⅛×4⅛″ Y Brace (YB)
   1—30″ total, fold top down 9¾″ Spine Plate (SP)
   1—Start with 110″ of webbing, Waist Belt (WB).
   2—57″ Leg Straps
   1—7″ Guide Strap
   1—19″ Brake Plate, start with 19″ of webbing, mark 1⅛″ from both ends and fold to that mark and HMG (hot melt glue). Will end with 17½″ Brake Plate.
B—2¼″ Nylon Webbing
   2—9⅜″ Elastic Line Storage Loop Bases, Outside Edges
   2—6″ Elastic Line Support Bases, Sides, cut at ½″ angle both ends, final length 5½″.
   1—8″ Elastic Line Support Base, Center
   1—15½″ D-Ring Anchor Strap
C—3″ Nylon Webbing
   2—14″ Face Support Panels
D—1″ 2500 lb. Black nylon webbing, approx. 18″.
   2—7″ EDS Rack Side Support Straps
   1—4½″ Brake Pin Guide (BPG), folded with double ¼″ grommets
   1—3″ Brake Pin D-Ring Strap with 1″ Stainless Steel D-Ring. Fold over and HMG
E—1″ 2500 lb. Red nylon webbing Suspension Relief Strap (SRS), 9′.
   1—9′ with 1¾″ of 1″ Hook Velcro sewn in place at a point beginning 5½″ from one end. (Between marks 5½″ and 7¼″ from one end).
F—1″ Kevlar 3500 lb. webbing, Offray #1781, appox 5′.
   Delta Cross Brake, three pieces of 1″ Kevlar webbing.
   1—8¾″ Brake
   1—7½″ Brake Anchor Strap
   1—8¼″ Brake Guide
   2—10″ Top EDS Rack Supports
   1—2¼″ Line Loop Guide
   1—9½″ EDS Rack Attachment Strap (EDSRAS), folded at center and sewn.
   1—6½″ Brake Pin Grommet Strap (BPGS), folded Kevlar strap with double grommets on the left side of the EDS Rack, end with 3¼″ after folded.
G—⅝″ 2800 lb. Red nylon webbing, must be high quality, tightly woven.
   1—64″Brake Strap, Weaver Leather #4058-Rd.
H—1″ 800 lb. Polypro webbing, approx. 3′
   2—17½″Clearance Strips, folded in half lengthwise and sewn, start with 17¾″ (will shrink when sewn ¼″).
I—EDS Rack—Forged Aluminum A356 T61, 40000 lb. tensile.
J—¼″ Stainless steel ss304 cold finish 3¾″ long pin total with polished 2⅝″ stem, ½″ ID welded eye.
K—¼″ Steel Spur Grommets, 4.
L— 3/16″ Tech 12 Sampson Technora® Line, 5,600 tensile, 44 feet finished line length with a 5″ loop on both ends (loops measured by extended length, not diameter).
M—330D Cordura material for Brake Pin Strap Cover, Brake Handle Cover and Back Cover, approx ½ yard of material.
N—Poly/Cotton material for Face Cover, 18½″ triangle with top point cut to leave 1½″ cut surface, both bottom corners cut to leave 2″ cut surface, approx. ¼ yard of material.
O—Velcro in 2″, 1″ and ⅝″ widths.
   1—2″×38½″×37½″ Left Face/Right Shoulder Loop Velcro, top end square cut, bottom corner is cut at 1″ angle (37½″ on outside edge).
   1—2″×20″×22″, Right Face Loop Velcro, the inside edge is longer than the outside edge, both ends cut at 1″ angle.
   1—2″ 16″×16″ Bottom Face Loop Velcro, both ends square cut (placed on first before left and right sides).
   1—2″×3″ Loop Velcro, center top of Y Brace over Top EDS Rack Supports.
   1—2″×3″ Loop Velcro, Cut at an angle on one end, Top Left Spine Plate.
   1—1″×1¾″ Hook Velcro, Suspension Relief Strap (SRS).
   1—1″×6″ Hook Velcro, Brake Plate.
   2—1″ Loop Velcro cut 2¼″×3⅜″, both ends angle cut, for bottom back outside corners.
   1—1″×3¼″ Hook Velcro, Brake Strap Cover Pin Flap Security Strip.
   1—⅝″×5″ Loop Velcro, Brake Strap.
   1—⅝″×1″ Loop Velcro, Brake Strap.
   1—⅝″×1″ Hook Velcro, Brake Strap.
P—3″ wide black heavy elastic material for 2-2¼″×3″ Elastic Storage Panels to hold the Suspension Relief Strap.
Q—1½″ wide black heavy elastic material (used for the Elastic Storage Loops and Elastic Support Panels that hold the line), approx. 5′.
   2—20⅝″ Elastic Storage Loops, Outside Edges.
   1—9⅜″ Elastic Support Loops, Center.
   2—5¾″ Elastic Support Loops, Sides, ¼″ angle cut on both ends, final length 5½″.
R—2 sets of Metal Safety Buckles for Leg Straps, Niagara Safety Products #350
S—2 sets of Metal Flat Buckles, for Waist and Chest Straps, Aluminum, ESS Design
T—4 Metal Slider Adjusting Buckles, for webbing adjustment on Legs and Shoulder Straps.
U—1-1″ Stainless Steel D-Ring
V—Tear Away D-Ring Cover, materials listed here for clarity;
   A—Cordura® Cover cut from template.
   B—1⅞″ webbing in the following lengths, 2-7″, 11½″, 11¾″, 1-12″×10½″(¾″ angle cut on both ends of one side.
   C—2-1″×5½″ webbing.
   D—Hook Velcro in the following lengths, 4-2″×3″, 2-2″×7″.
   E—Loop Velcro, 2-2″×3″
   F—D-Ring Anchor Strap, 15½″×2¼″ webbing.
   G—D-Ring, Yoke, 2¼″ throat.
W—13″×5″ Warning Label for Brake Handle Cover, Poly material.
X—3×2″ Rescue One EDS logo embroidered on Center of Lower back cover.

### Harness Assembly Steps

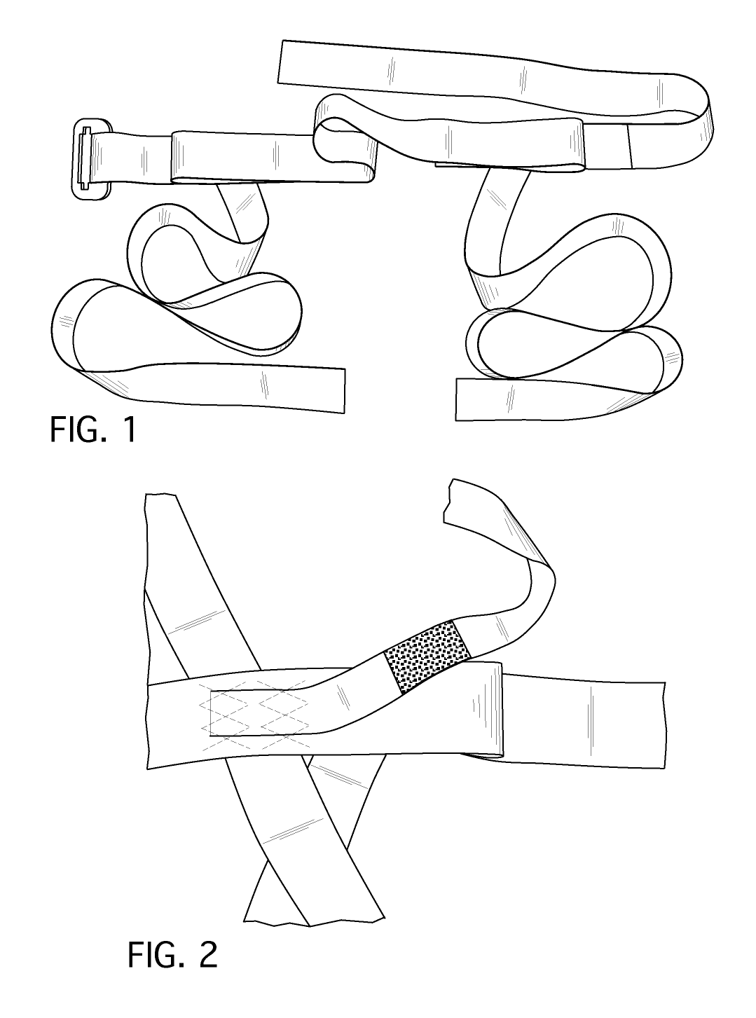

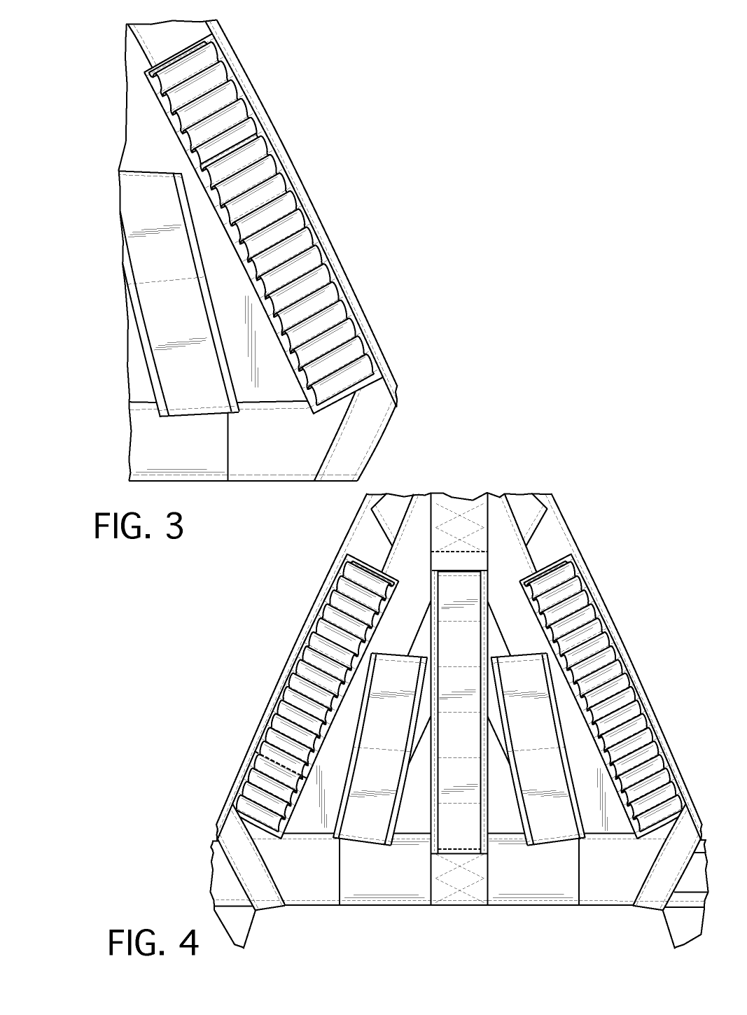

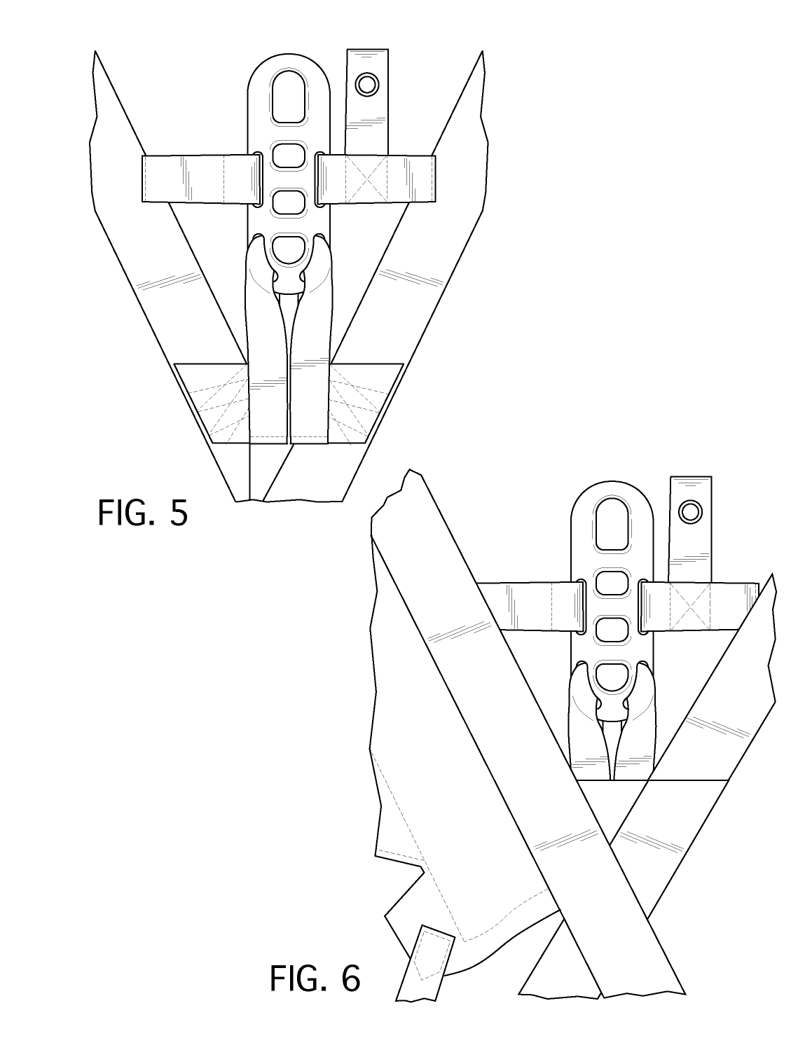

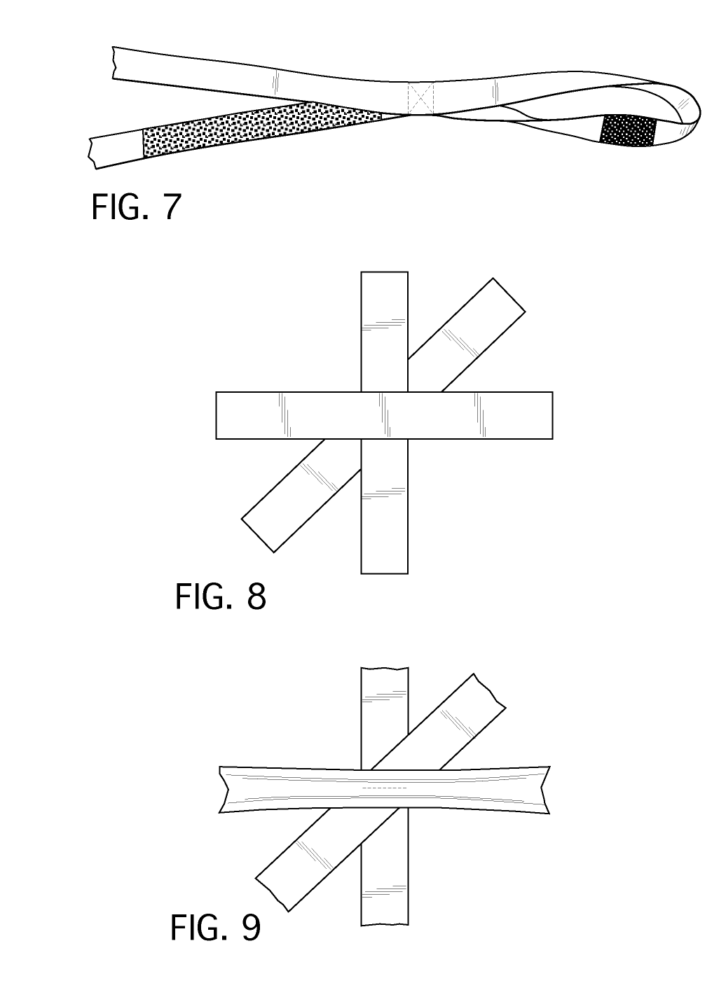

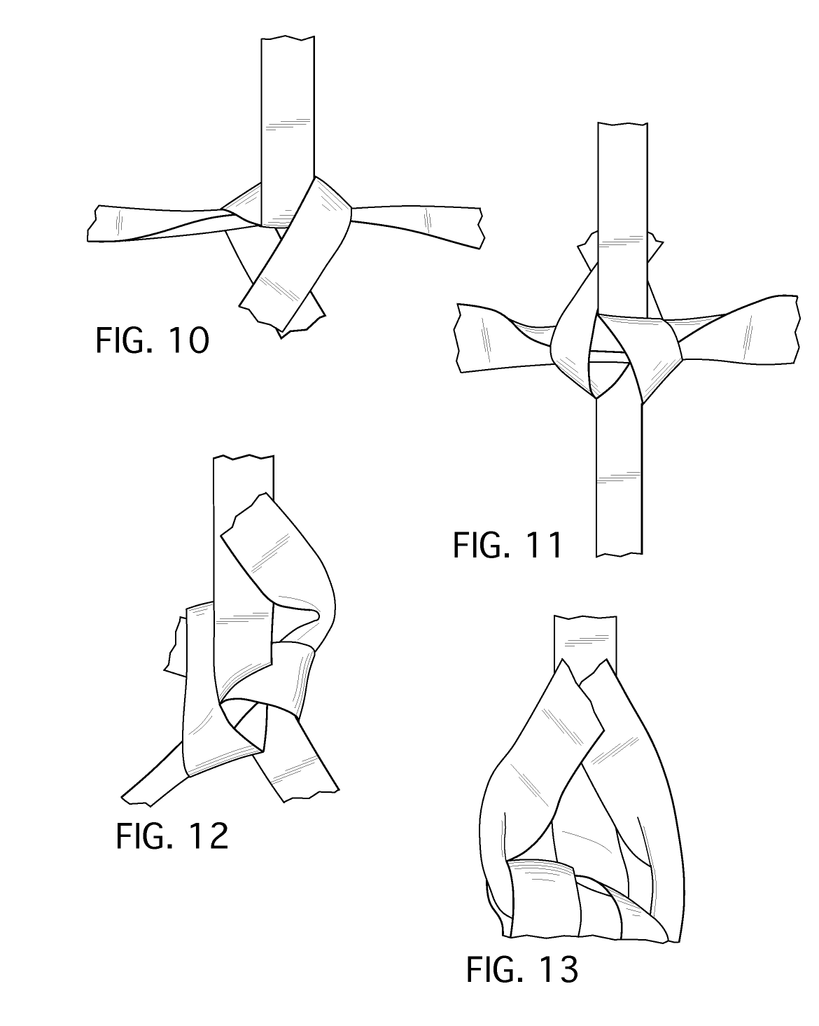

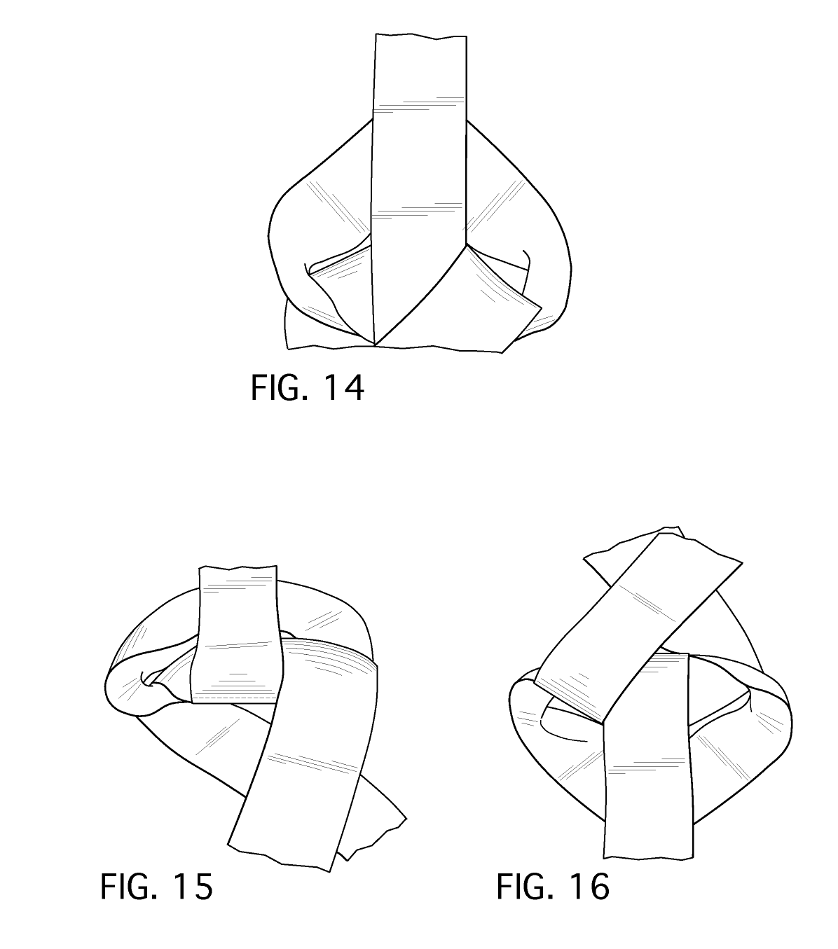

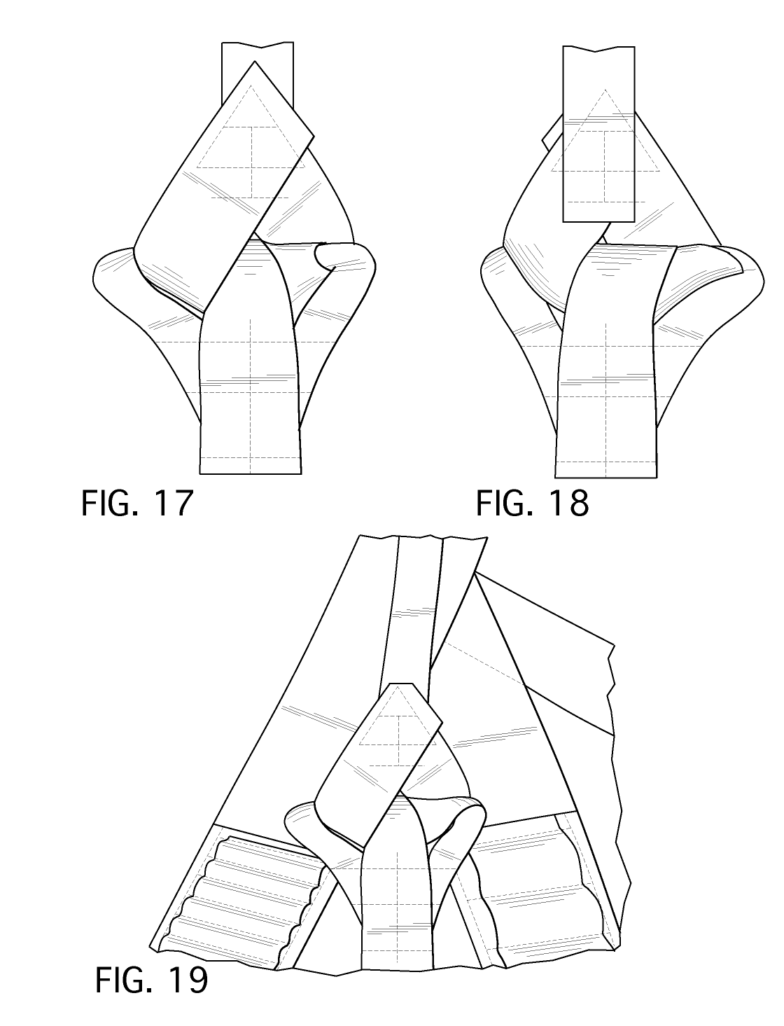

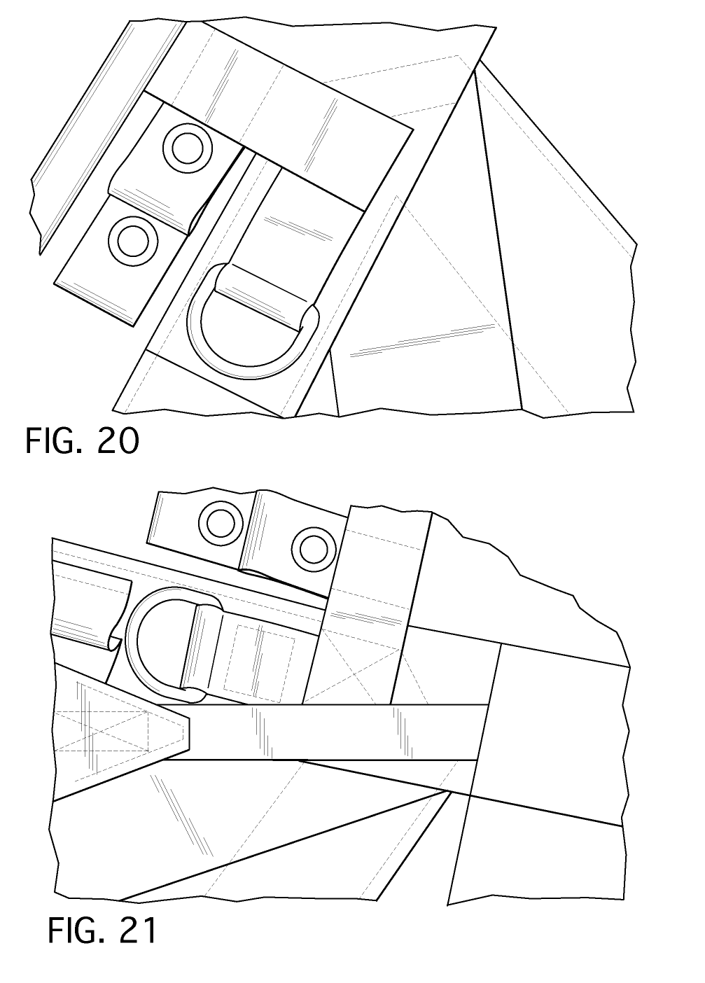

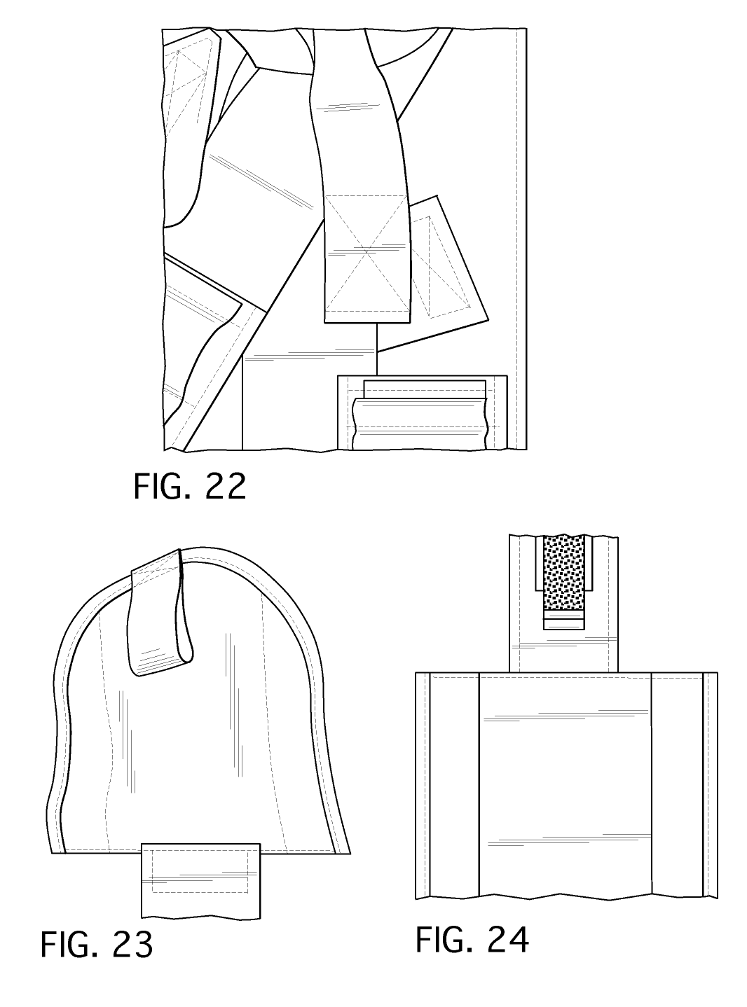

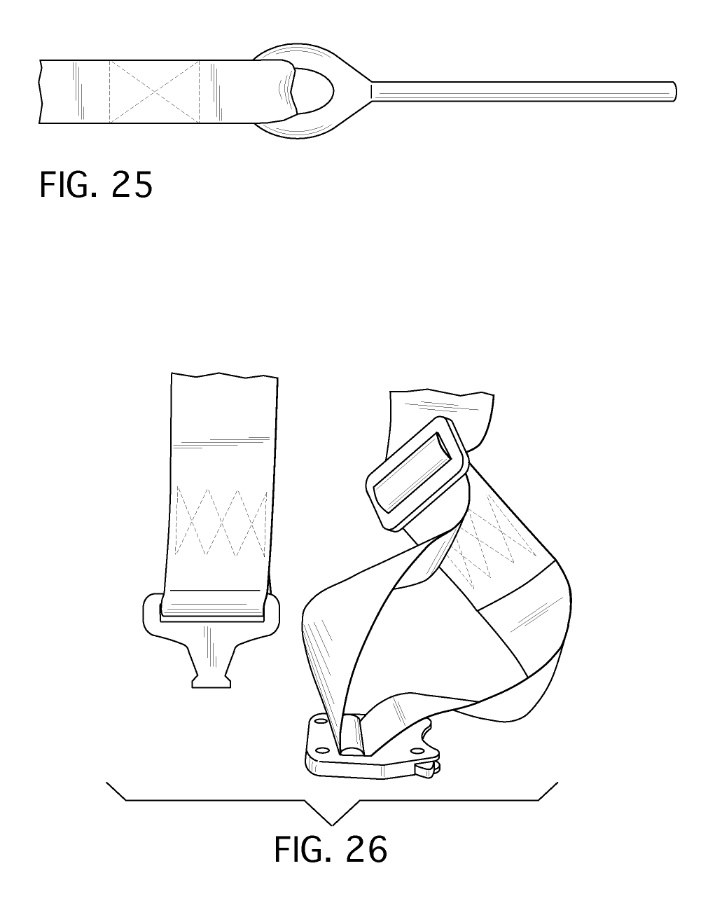

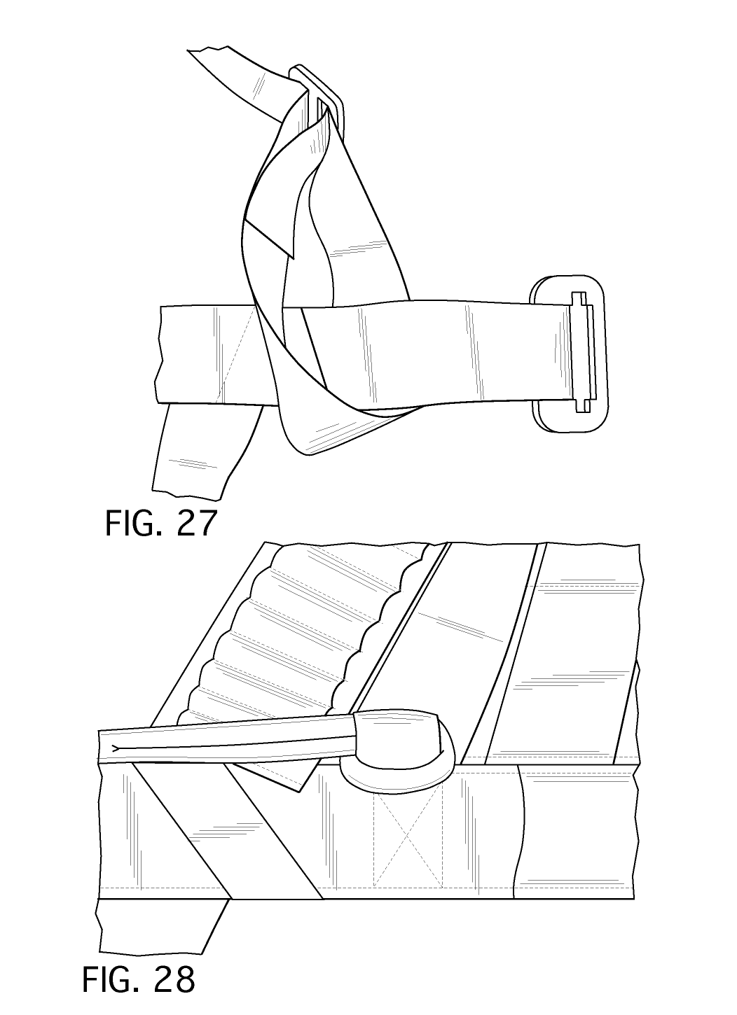

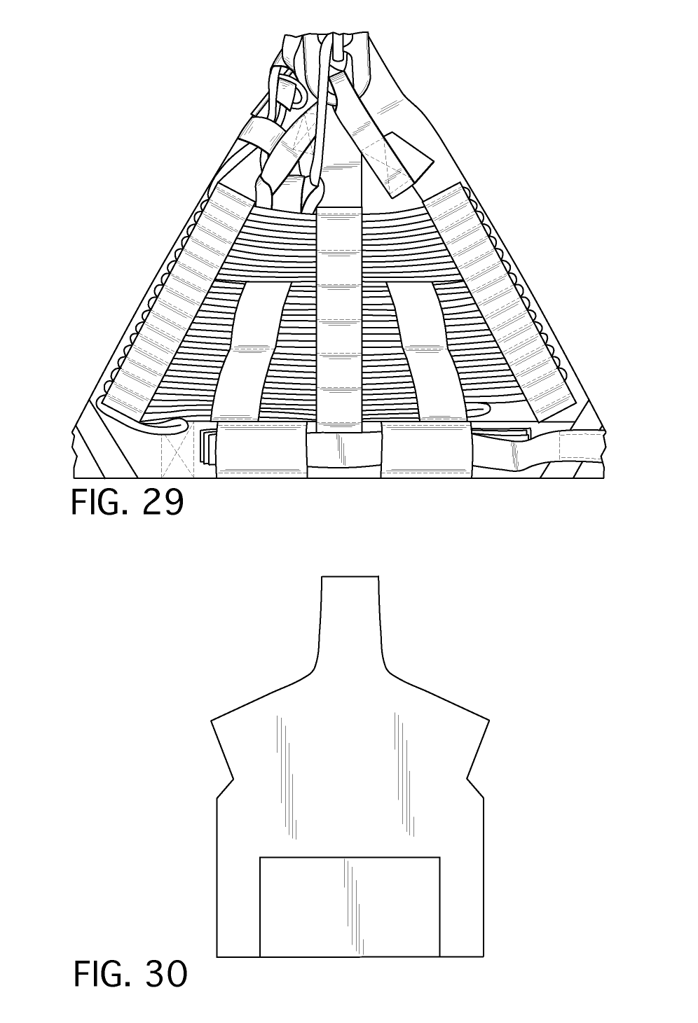

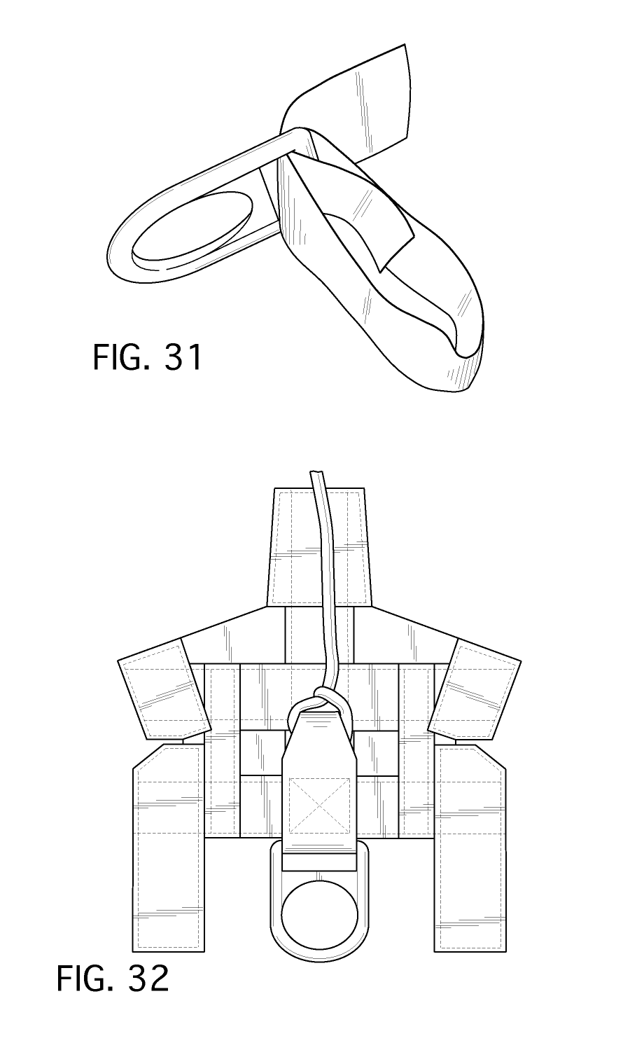

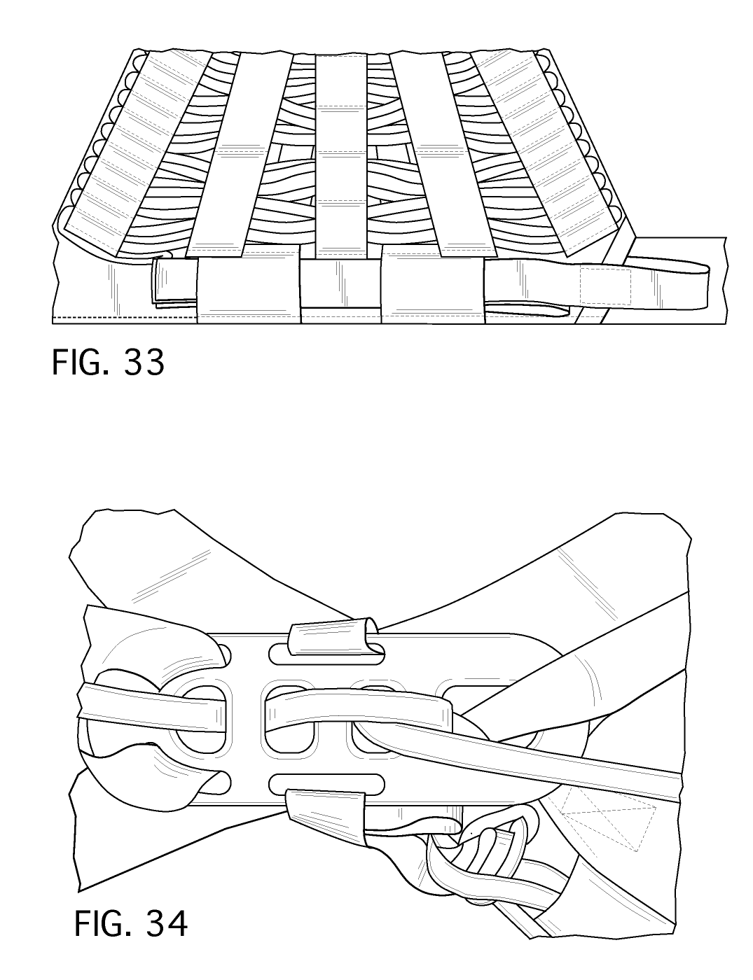

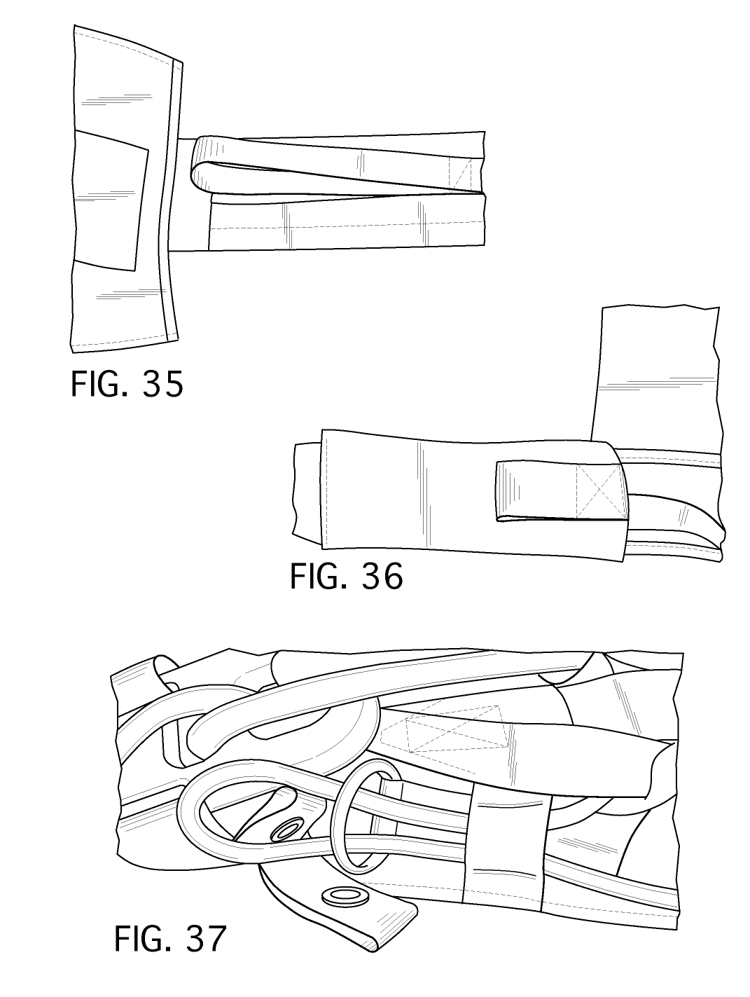

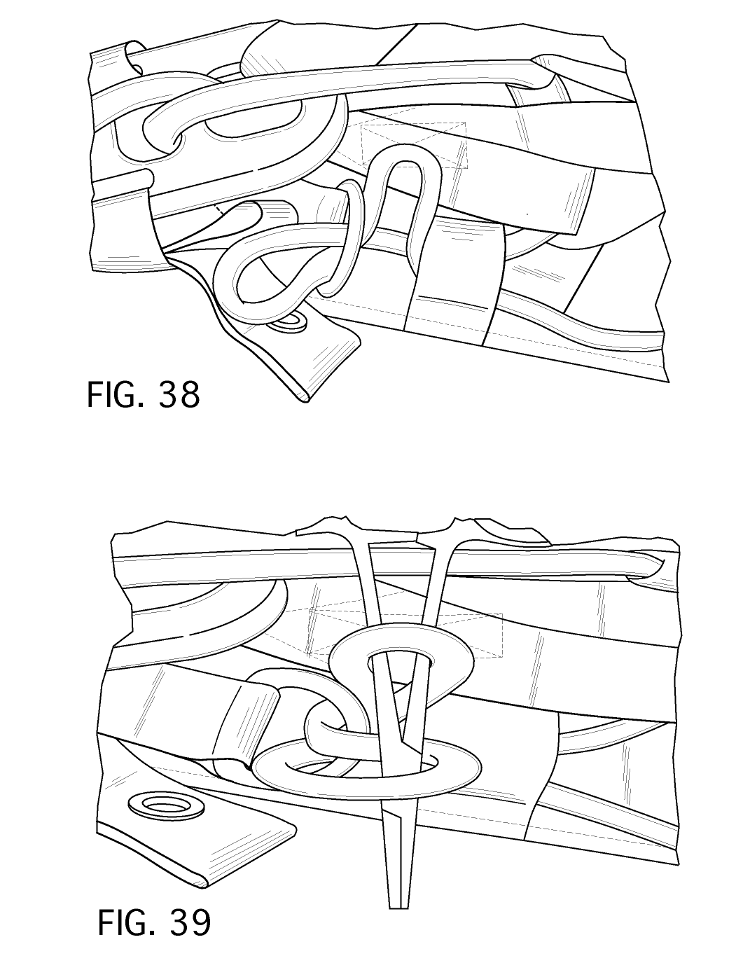

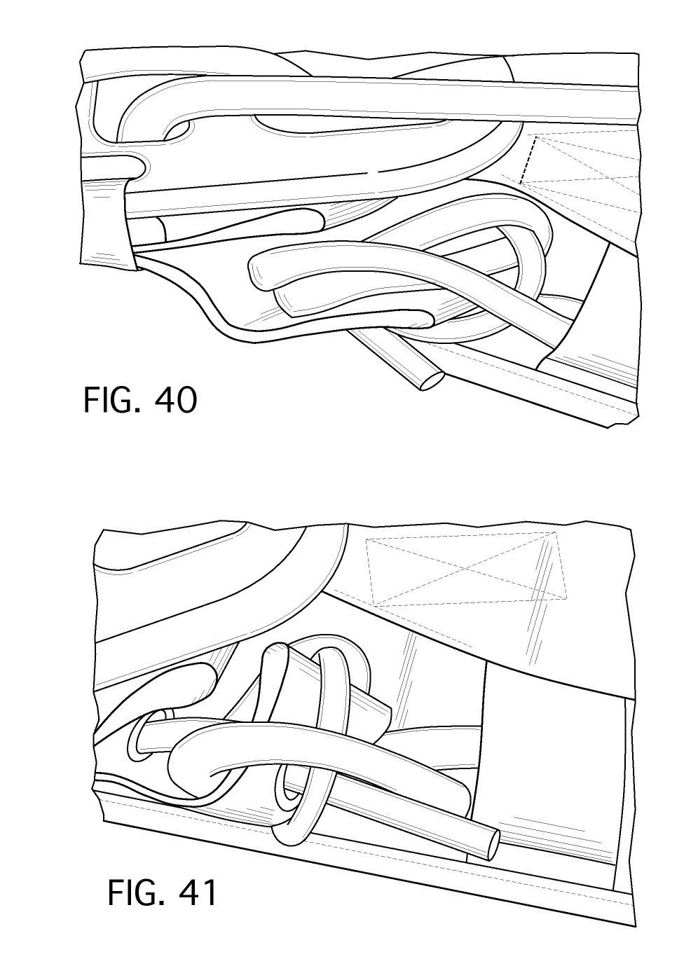

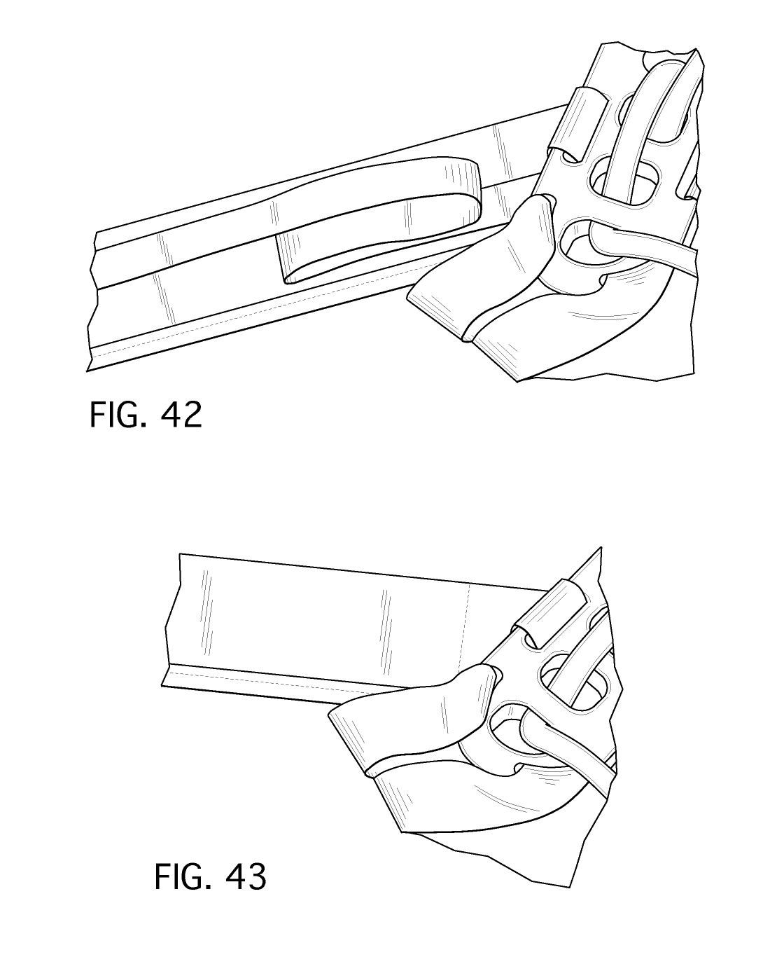

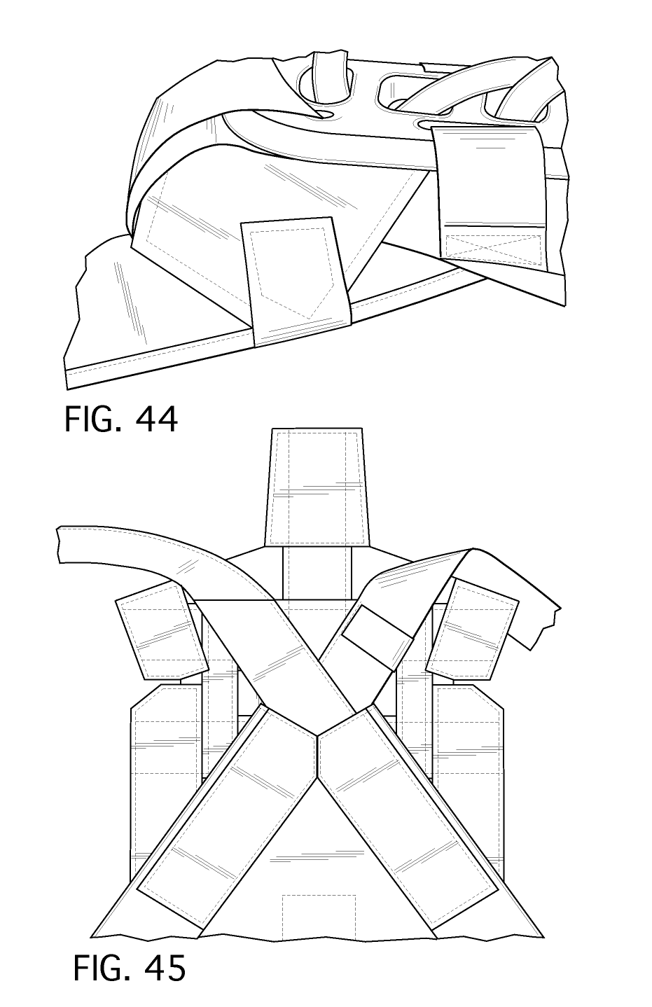

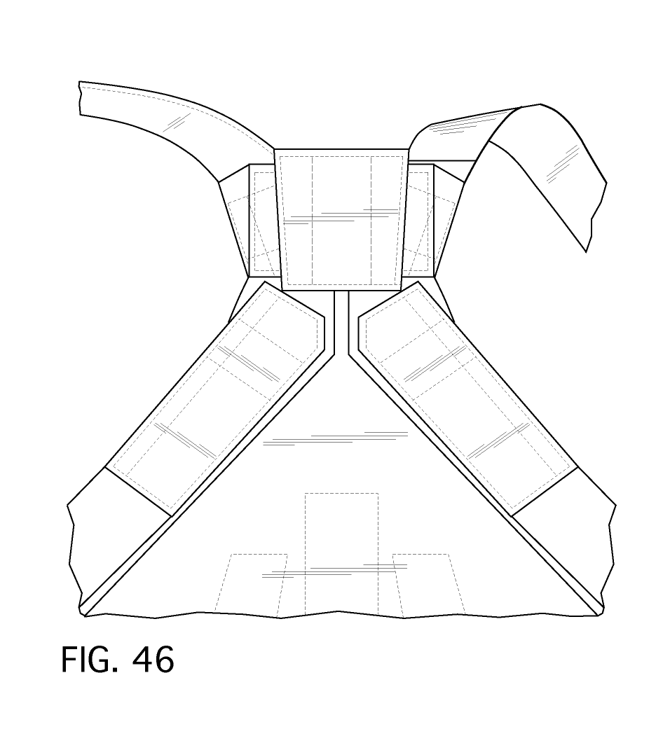

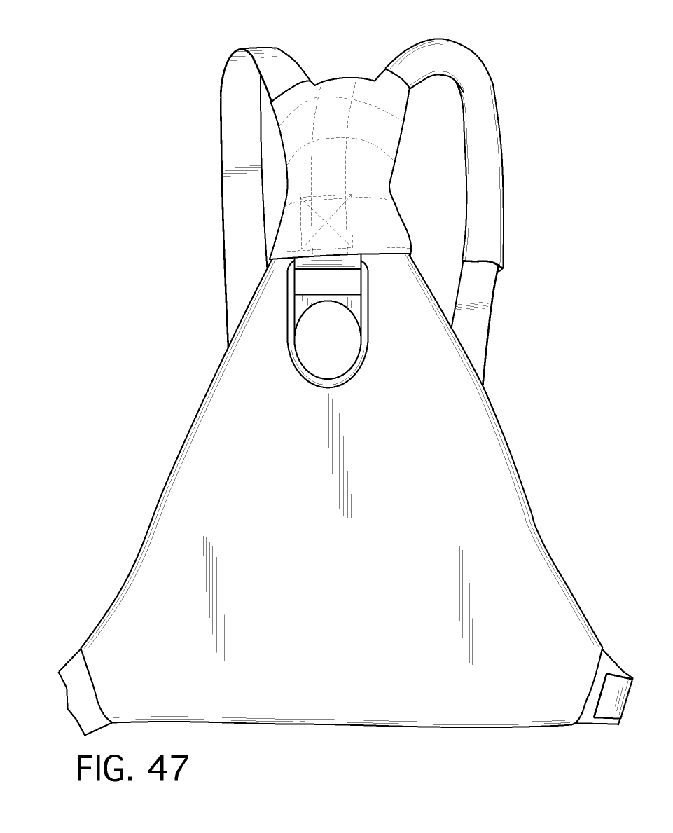

Heavy Sew with 270 Bonded Poly thread, WW Tacker 135 Bonded Poly thread, Kevlar 138 Bonded Natural Thread
1—Assemble Suspension Relief Strap, 9 feet of 1″ 2500 lb Red Nylon Webbing. Sew 1¾″ of 1″ Hook Velcro 5½″ from one end.
2—Assemble the Waist Belt, Start with 110″ of webbing.
   A—Place the 57″ Left Leg Straps at approx. 60 degree angle at a point 15½″ from the stop which will be the left end of the waist strap.
   B—Place Waist Strap over the Leg Strap end and Hot Melt Glue (HMG).
   C—Place Female Flat Buckle over the end of the Waist Strap and fold end back to a point 16″ from the stop.
   D—Fold down Leg Strap at an angle over the Waist Strap and HMG.
   E—Make marks at 1¾″ and 3½″ from folded left end of webbing in the Female Buckle. This will be where the WW tacker will sew between the marks.
   F—Mark 21½″ and 53″ from left folded webbing end. These two marks will be the Lineman's Loops Center Marks of the Left (21½″) and Right (53″).
   G—Mark at 4½″ from left folded webbing end.
   H—Fold webbing in half at the 21½″ mark and place it on the 4½″ mark forming the Left Lineman's Loop. HMG both layers to the RIGHT of the Leg Strap ONLY.
   I—Place Right Leg Strap 49½″ from the left folded webbing end stop and HMG Waist strap over the Right Leg Strap.
   J—HMG 7″ Guide Strap on Waist Strap between 48″ and 55″ from left Waist Strap stop.
   K—Fold Right Leg Strap down and over Waist Strap at an angle and HMG.
   L—Mark at 52½″ from Left Folded Webbing End on the Guide Strap.
   M—Fold the 53″ Right Lineman's Loop Center mark in half and pull it back to the 52½″ mark forming the Right Lineman's Loop, HMG.
   N—Mark 3″ from RIGHT Waist Strap end.
   O—Finished Waist Belt. FIG. 1—In order listed below, lay all parts in jig as stated and Hot Melt Glue (HMG) in place. Basic harness structure is 18″ triangle measured from the center of all three corners.
4—Add Y Brace to top of harness, top edge of Y Brace will be 3¾″ above top center crossing. Add Elastic Loop Brace Bridge Straps (ELBBS) 4½″ above the center of lower corners, parallel with and half way over the shoulder strap locations.
5—Add Left Shoulder Strap, Right Shoulder Strap will overlap the left, both shoulder strap bottoms will extend 11″ below the waist belt lower edge, measured along the inside edge of shoulder straps (these extensions become the short Male Buckle Leg Straps.
6—Add Line Loop Braces, lowest corners will be 2¾″ from inside edge of Shoulder Strap measured along bottom edge of waist belt location and highest corners will be 13½″ from bottom center corners, bottom edges even with lower edge of Waist Belt line.
7—Add Elastic Loop Braces along side of Shoulder Straps.
8—Add Spine Plate, with 9.5″ fold underneath and top even with top of Y Brace.
9—Add Right Shoulder Strap overlapping Spine Plate.
10—Waist Belt over harness back.
11—Showing 18″ from Center of left bottom harness crossing to Center of right bottom harness crossing.
12—Showing 18″ from Top Center Crossing to Center of right bottom crossing.
13—Left Lineman's Loop.
14—HMG the SRS end over the Waist Belt, centered and with the left lower end corner of the SRS even with the inside edge of the Right Leg Strap, Hook Velcro facing up.
15—WW sew all parts, there are 31 WW Tack. FIG. 2
16—Heavy sew the Right Lineman's Loop with sewing centered and parallel with the Long Leg Strap and then the SRS, sewing in a V, see the next two photos. The sew over the SRS will be parallel to the Short Right Leg Strap. Then sew the Left Lineman's Loop.
17—HMG both 14″×3″ Webbing Face Support Panels on the Face side of the harness, WW Sew with 12 sews on each panel.
18—HMG face cover on same side as Support Panels with narrow cut end at top.
19—HMG 2″ loop Velcro around all edges over Face Cover EXCEPT ABOVE TOP CENTER CROSSING, NEED TO SEW CDS RACK TOP SUPPORTS BEFORE FINAL SEWING OF VELCRO. Place the 16″×16″ Bottom Face Loop Velcro on FIRST between the Short Leg Straps over the Waist Belt. Second place the 20″×22″ Right Face Velcro (left side facing up). Last place the 38½″×37½″ Left Face/Right Shoulder Velcro on, it will overlap the right side.
20—HMG 2¼″×3¼″×1″ loop Velcro on bottom of right and left rear lower BACK corners.
21—HMG top and bottom edge of 3″w×1⅞″h Elastic SRS Securing Panels to bottom of harness back. Both start ¼″ on each side of spine plate.
22—HMG 2¼″×1″ Kevlar Line Loop Guide (KLLG) on the left upper side of the BACK, 3½″ below Top Center Crossing, HMG only the ends to each side of the left side webbing forming a loop.
23—Sew all around inside and outside edges of harness outside edge webbing with Face Down. SEW ON THE SIDE OF THE WEBBING AND NOT VELCRO. Do not sew above top center crossing. When sewing, double sew across the KLLG ends.
24—Form Elastic Line Loop Storage Panels:
   A—Cut 2 Bases 9⅜″×2¼″ webbing, mark every ½″ leaving 3/16″ on each end.
   B—1½″ wide Elastic×20⅝″, mark every 1⅛″, leaving 3/16″ on each end.
25—Sew Elastic to Base forming 18 loops, aligning marks.
26—Form Elastic Line Support Panels:
   A—Center Base, 8″×2¼″, mark every 1¼″, leaving ¼″ on each end.
   B—Center Elastic, 1½″×9⅜″, mark every 1½″, leaving 3/16″ on each end.
   C—Side Bases 2-5½″×2¼″, cut top and bottom at ½″ angle, start with 6″.
   D—Side Elastic 2-1½″×5½″, cut top and bottom at ¼″ angle, start with 5¾″.
   E—Sew Center Panel at markings, forming 6 loops.
   F—Sew Side Panels at top, middle and bottom, forming 2 loops each. Side panels will be opposites. FIG. 3
27—HMG Elastic Line Loop Storage Panels as follows;
   A—Place Right Panel left lower corner ½″ below top edge of waist belt, with Right side of loops ½″ inside of Right Harness edge.
   B—Place Left Elastic Loop Line Storage Panel right lower corner ½″ below top edge of Waist Belt, with Left Side of Loops ⅜″ inside of Left Harness edge.
28—HMG the Elastic Line Support Panels as follows;
   A—Place Center Support Panel over Spine Plate with bottom edge extending ¼″ below top edge of Waist Belt.
   B—Place both Angled Side Support Panels between the Side and Center Panels with both bottom edges extending ¼″ below top edge of Waist Belt. Both Lateral Sides of the Angled Side Support Panels will extend ½″ past the Lateral edge of each SRS Elastic Storage Panels. FIG. 4
29—Heavy sew all Elastic Storage and Support Panels around the outside edges.
30—Assemble the EDS Rack as follows;
   A—Assemble the Left EDS Rack Support Strap as follows;
      a—Punch two holes in the 6½″×1″ Kevlar Brake Pin Grommet Strap, one hole will be 2⅜″ from one end and the other hole will be 2½″ from the opposite end. The holes will be 1½″ from each other's center.
      b—Press ¼″ Stainless Steel Gommets into both Kevlar Brake Pin Grommet Strap holes, make sure Grommets are facing opposite directions.
      c—Punch two holes in the 4½″×1″ Brake Pin Guide, one hole will be 1⅜″ from one end and the other hole will be 1½″ from the opposite end. The holes will be 1½″ from each other's center.
      d—Press ¼″ Stainless Steel Gommets into both Brake Pin Guide holes, make sure Grommets are facing opposite directions.
   B—Fold in half the Kevlar Brake Pin Grommet Strap (3¼″) and the Brake Pin Guide (2 3/16″) and HMG, the grommet WASHERS will be pointing up and will be offset so you can see the bottom edge of the underneath grommet washer thru the top grommet's hole. This allows the holes to line up when the straps are bent to insert the Brake Pin.
   C—HMG the Brake Pin Guide onto the Kevlar Brake Pin Grommet Strap with the WASHERS pointing up creating the Combined Grommet Straps.
   D—HMG 7″ EDS Rack Side Support Strap over the Combined Grommet Straps at 90 degree angle and Combined Grommet Straps pointing down, there will be 1½″ space left on the right end of the EDS Rack Support Strap.
   E—Place the Left EDS Rack Support Strap up thru the Left Side Slot on the EDS Rack and HMG the ends together. The Kevlar Brake Pin Grommet Strap will be on top and the Combined Grommet Straps will be pointing towards the bottom of the EDS Rack. There will be ⅜″ space between the EDS Rack and the Combined Grommet Straps.
   F—Heavy sew the Combined Grommet Straps to the Left EDS Rack Side Support Strap.
   G—Place the two 10″ Kevlar EDS Rack Top Support Straps and the 7″ Right EDS Rack Side Support Strap in their slots on the EDS Rack. Sew across the Right EDS Rack Side Support Strap next to the EDS Rack.
31—HMG Kevlar® EDS Rack Top Support Straps to middle of Y Brace. Extend Top Supports down so they are even with bottom of Y Brace on harness face. The Combined Grommet Straps will be on the Right and pointing up. Heavy Sew Top Supports to Y Brace and Harness. FIG. 5
32—Assemble the Brake Pin Strap Cover as follows:
   A—Cut Cordura material 14″×6½″
   B—Fold Left long side 1″ and HMG
   C—Fold both top and bottom edges ¾″ and HMG
   D—HMG 12½″ Hook Velcro over long folded side
   E—HMG 1¾″ Loop Velcro along bottom edge adjoining the Hook Velcro
   F—Cut a V Notch into the Hook Velcro beginning at 2″ below the top edge and along the left edge of the Hook Velcro. The bottom opening of the notch will be 4¼″ down from the top edge along the left edge of the Hook Velcro. The bottom of the V of the notch will be 2⅞″ down from the top edge and along the right edge of the Hook Velcro. The lower edge of the V Notch will be longer than the upper edge of the V Notch.
   G—Sew along the outside and inside edges of the folded sides, sewing along inside of the Hook Velcro and V Notch.
33—HMG and Sew 1″×3¼″ Hook Velcro on BPSC with 1½″ overlap aligned with top right point.
34—HMG Brake Pin Strap Cover (BPSC) to underside of the beginning of the right shoulder strap. Start at right outside edge of the Top Center Crossing and place long cut edge 1″ onto the right shoulder strap. The notched side of the BPSC will be to the outside with the Hook Velcro down.
35—HMG 3″×2″ Loop Velcro at the center top of the Y Brace over the CDS Rack Supports. The 3″ side will be even with the top of the Y Brace.
36—HMG the remaining 2″ loop Velcro up to top of Y Brace on Left and down Right Shoulder Strap above crossing, over the BPSC edge and down the right shoulder strap. FIG. 6
37—HMG 2×2×3″ loop Velcro with top edge cut at an angle on Top Left of Spine Plate on back of harness.
38—Sew loop Velcro on Top Left Face and Center over the EDS Top Support Straps ONLY. Do this by sewing the Inside edge of the Right Shoulder Strap Loop Velcro from the Top Center Crossing to the top of the Y Brace and then over the Center Loop Velcro and finally the remainder of the Left Shoulder Strap Loop Velcro. Sew 2×3″ loop Velcro on Top Left Spine Plate also at this time. DO NOT SEW PAST TOP OF Y BRACE ON THE RIGHT SHOULDER LOOP VELCRO. DO NOT SEW OUTSIDE EDGE OF RIGHT SHOULDER STRAP LOOP VELCRO. DO NOT SEW DOWN RIGHT SHOULDER STRAP. This section of Loop Velcro will be sewn when the Brake Plate is sewn to the Right Shoulder Strap. Sew in a triangular C-shaped pattern.
39—Sew the Inside, Outside and Bottom Edges of the last 4″ of loop Velcro extended down the right shoulder strap.
40—Assemble Brake Plate as follows:
   A—Start with 19″ of 1⅞″ webbing, mark 1⅛″ from both ends. Fold both ends to these marks and HMG, will end up with 17½″.
   B—HMG and SEW 6″×1″ Hook Velcro centered on one end and adjoining the cut end of the fold.
   C—HMG on both 17½″Clearance Strips (CS), (folded in half 800 lb polypro and sewn) to the underside outside edges of the Brake Plate. Make sure rounded/fold edge of CS is towards center of Brake Plate.
41—HMG the Assembled Brake Plate onto the Right Shoulder Strap. Start at Top Center Crossing on the back aligning with the bottom edge of the BPSC on the face and go down the right shoulder strap. Heavy Sew the Brake Plate along both outside edges, sewing thru the Clearance Strips and double tacking the ends securely.
42—Assemble 64″×⅝″ Red Brake Strap as follows, sew with 138 Kevlar Thread:
   A—Mark from one end 22¼″, 27¼″, 28″, 28½″, 40″, 40½″.
   B—On the opposite side, mark 22¼″, 23¼″, 28″, 28½″, 32¼″, 33¼″, 59½″.
   C—HMG 5″ of ⅝″ LOOP Velcro between the 22¼″ and 27¼″ marks.
   D—On the opposite side HMG 1″ of LOOP Velcro between 22¼″ and 23½″ marks.
   E—HMG 1″ of HOOK Velcro between the 32¼″ and 33¼″ marks on the same side.
   F—Sew all Velcro to Brake Strap.
   G—Fold Brake Strap to align the 28″ and 28½″ marks to the 40″ and 40½″ marks.
   H—Sew between the 28″ and 28½″ marks creating the Handle Loop. There are two free ends created. The top free strap with no Velcro is the Brake Pin Strap. The bottom strap with the attached Velcro is the Brake Strap. FIG. 7
43—Create the Kevlar Delta Cross Brake (KDCB) as follows: FIG. 8
   A—7½″ Brake Anchor Strap (BAS) is vertical with center being 3½″ from top.
   B—8¾″ Brake Strap is laid across BAS at a 45 degree angle and centered.
   C—8¼″ Brake Guide is laid across the Brake Strap at a 90 degree angle to the BAS.
   D—Mark ½″ down from top of BAS
   E—Sew 1″ across the Brake Guide center.
   F—Fold Brake Guide up lengthwise along the sewing line. FIG. 9
   G—Fold Brake left bottom end up over the Brake Guide and fold the right upper end down over the Brake Guide pulling the ends together towards the back side of the Brake Anchor Strap and HMG aligning both outside top corners. The Brake Anchor Strap is folded over the Brake and Brake Guide, HMG the ends together, pointing down. FIG. 10
   H—Fold both Brake Guide Ends backwards and HMG to BAS with top edges even with the ½″ line on the BAS. FIGS. 11-13
   I—Fold lower section of BAS up and over the upper section of BAS. The lower Section is ½″ longer than the upper section and will extend above the upper section ½″. FIG. 14
   J—The Center Sewn area will be Centered on the BAS fold. FIG. 15
   K—Fold the ½″ longer BAS strap over the shorter one and HMG.
   L—Finished Kevlar Delta Cross Brake. FIG. 16
44—Sew KDCB as shown with 138 Kevlar thread.
45—Trim the non-overlapped edges and HMG the Kevlar Delta Cross Brake on top of the end of the Brake Strap on the SAME side as the 5″ Loop Velcro and heavy sew trimmed edges and Brake Strap. Brake Strap end will extend down to the top of the Delta opening. FIGS. 17-18
46—Attach the Kevlar Delta Cross Brake to the back of the harness as follows:
   A—HMG the Brake Anchor Strap bottom edge 8¼″ down from the Top Center Crossing and 3″ from the Left harness edge. The tip of the Kevlar Delta Cross Brake will be pointed towards the center of the Brake Plate Opening. FIG. 19
47—Heavy sew the Bottom 2″ of the Brake Anchor Strap.
48—HMG the Left EDS Rack Side Support Strap to the harness by laying the Left Side Support across the left edge of the harness with the top edge of the Left Side Support even with the Top Center Crossing. The Kevlar Brake Pin Grommet Strap will be facing down next to and parallel with the left edge of the harness. FIG. 20
49—HMG the 1″ D-Ring and 3″ Folded Strap next to the Left EDS Rack Side Support Strap with the cut ends of the D-Ring Strap against the Left EDS Rack Side Support Strap with the inside edge of the D-Ring Strap even with the cut ends of the Left EDS Rack Side Support Strap. Heavy sew across the Left Side Support ¼″ from the edge of the harness, sew over 1″ area. Sew close to the D-Ring and over a 1″ area.
50—Pull the Brake Strap thru the Brake Plate Tunnel. FIG. 21
51—HMG and Heavy Sew the Right EDS Rack Side Support along Right edge of harness with the end of the Right Side Support extending 1½″ down past the Top Center Crossing, next to and parallel with the right edge of the harness. Begin Heavy Sewing ¼″ below Top Center Crossing and sew over 1″ area.
52—Form the EDS Rack Attachment Strap (EDSRAS) as follows:
   A—Fold in half long ways the 9½″×1″ Kevlar strap and sew with 138 Kevlar Thread across at 4¾″.
53—Place EDSRAS thru the EDS Rack large bottom hole with the folded edge towards the middle of the EDS Rack. HMG the EDSRAS so it extends 5¼″ below the Top Center Crossing and 1½″ from the Right Harness edge and parallel to the Right Harness edge. Heavy Sew the bottom 2 inches of the EDSRAS. FIG. 22
54—Assemble and attach the Brake Strap Cover as follows:
   A—Start with 7¼″×9⅛″ Cordura® Material. Measure from top and bottom 1½″, fold to this mark and HMG.
   B—HMG 1″×1″ Loop Velcro, 2″ down from top and centered on the face.
   C—HMG 6″ of 1″ Hook Velcro along both long top sides, starting at the bottom.
   D—Fold both Velcro covered sides long ways and underneath, and HMG.
   E—Create Pull Tab with 6″ of 1″ webbing. HMG and sew 1″ Hook Velcro 2″ from one end. HMG and sew 1″ Hook Velcro on the same side far end.
   F—Fold Pull Tab in half, HMG and sew the two ends to the Top of the BSC with the Hook Velcro on the end on top. This will align the Hook Velcro on the underneath side of the Pull Tab with the Loop Velcro on the Brake Strap Cover face.
   G—Sew around all edges of the BSC and the center 1″ Loop Velcro on the face.
   H—HMG and sew the Emergency Instructions bottom right edge to the underside of the BSC, directly opposite the center Loop Velcro on the face. DO NOT SEW THRU THE PULL TAB END.
55—HMG bottom edge of Brake Strap Cover (BSC) to Right Shoulder Strap 1″ below farend of Brake Plate (15″ below the Y Brace). The BSC with be able to extend up and over the Brake Plate. The warning label is already connected to the BSC. Sew BSC only ACROSS bottom edge that is overlapping right shoulder webbing. FIGS. 23-24
56—Insert the end of the Brake Pin Strap up through the eye hole of the ¼″×3¾″ Brake Pin. Fold strap back to the 59½″ mark, HMG and Sew end securely over 1″ area. The cut end of the Brake Pin Strap will be ON TOP. FIG. 25
57—Attach Adhesive Warning Labels and Rope Threading Diagram. Mark 16″ down on both shoulder straps from the inside edge measured from the Y Brace. Mark 6″ from the ends of both Shoulder Straps and all Leg Straps, this mark will be on the Face Side.
58—Place on all remaining Safety Buckles and Metal Slider Adjusting Buckles on Leg Straps. Fold over 3″ and WW Sew on all terminal ends. The Male Safety Buckle will be on the Short Leg Strap. FIG. 26
59—Place the Tri Glide Adjusters on both Shoulder Straps and place both straps through the same side Waist Belt Loops. Take both cut ends and place around Center Tri Glide post, overlap 3″, HMG and Sew. FIG. 27
60—HMG and Sew Chest Straps on. Sew both with the top edges 16″ from Y brace measuring along inside edge of each shoulder strap. The underside of Left Female Chest Strap, 8″ strap is folded back 3″ to secure the Flat Female Buckle and WW Sewn. HMG to the underside of the Left Chest Strap 2″ and WW Sewn.
61—HMG and Heavy Sew the folded 5″×1″ Line Anchor Strap to the Left side Waist Belt half way between the Left Line Storage Loop Panel and the Left Line Support Panel. The folded end will be pointing towards the top of the harness and the two cut ends will be even with the bottom of the Waist Belt, Heavy Sew the bottom 1¼″ leaving an upper loop.
62—Place loop of the Technora® line thru the Anchor Strap Loop and thread it thru itself. FIG. 28
63—Place the remainder of the line into the Storage and Support Panels starting at the bottom of the harness and work your way up.
64—Thread the line thru the Kevlar® Delta Cross Brake and EDS Rack. FIG. 29
65—Create the Tear-Away D-Ring Cover (TADRC) as follows;
   A—Mark out the Cordura material with the Pattern Template and cut. FIG. 30
   B—HMG the webbing onto the TADRC as shown. 11½″ is vertical, 12″×10½″ is horizontal middle, 11¾″ is horizontal bottom, 2-7⅛″ are bottom side verticals with 1″×5½″ next to them.
   C—HMG the Hook Velcro over the Webbing and the Loop Velcro on the opposite side.
   D—Trim, cut and sew. Both 7″ Leg Sections Top Edge must be cut to the 1″ webbing.
   E—Assemble D-Ring Strap. Mark at 8″ on the 15½″×2¼″ webbing. Sew in Thirds at this mark. HMG D-Ring Strap to D-Ring as shown, strap will be 4½″ long. FIG. 31
   F—HMG and Heavy Sew D-Ring Strap to TADRC. Top of D-Ring will be even with the bottom of the cover and cut end of D-Ring Strap will be against cover. The top of the D-Ring Strap forms a Loop to attach the Line.
66—Place the Line 5″ End Loop thru the D-Ring Strap Loop and place the complete TADRSC thru the Loop so the Line is secured to the D-R Strap Loop as shown. FIG. 32
67—Fold SRS back and forth and place in Elastic Storage Panels so SRS deploys from top layer down. FIG. 33
68—Set Brake, Brake Pin as follows: FIG. 34
   A—Pull Brake Strap Loop until Brake is tight and approx. ½″ of red strap is showing between the Loop Velcro and the end of the Brake Plate. Fold Brake Strap onto the Brake Plate and attach to Velcro.
   B—Fold Brake Strap Loop down to its Velcro and Fold Brake Strap Cover with Emergency Instructions over the Brake Strap Loop and attach to its Velcro. FIGS. 35-36
   C—Pull Line up through the Kevlar Line Loop Guide and 1″ D-Ring. FIG. 37
   D—Make two loops as shown on each side of the 1″ D-Ring with the line coming from the Elastic Storage Loops. FIG. 38
   E—Brake Pin will insert in the direction of the instrument shown. The lower loop will come over the top of the 1″ D-Ring and will be on the inside of the upper loop. FIG. 39
   F—Insert the Brake Pin through the Brake Pin Guide First, then through the two created loops in the same direction as the instrument was and then through the Kevlar Brake Pin Grommet Strap. FIG. 40
   G—Finally shove the pin through the 1″ D-ring as far as it will go. FIG. 41
   H—Fold the remaining Brake Pin Strap onto the Brake Plate near the EDS Rack. FIG. 42
   I—Fold the Brake Pin Strap Cover over the Brake Pin Strap and attach with its Velcro. The notched section goes under the EDS Rack and attaches to its Velcro and the Brake Pin Strap Cover Security Strip Hook Velcro rolls over the edge and attaches to the face. FIGS. 43-44
69—Create Back Cover; Height is 18″×22″ at the widest point. The Top edge is 13″ wide and the bottom edge from center of each outside curve is 13½″. Loop Velcro on the Top Outside Edge is 7½″×2″. 2″ Loop Velcro is around inside edge except along the top. Long Outside Edge is 12½″, Short Outside Edge is 7″.
70—Place Back Cover and Tear-Away D-Ring Cover on harness and attach all Velcro. Industrial EDS Harness is complete. FIGS. 45-47

While certain illustrative embodiments have been shown in the drawings and described above in considerable detail, it should be understood that there is no intention to limit the invention to the specific forms disclosed.

What is claimed is:

1. An industrial emergency descent system (EDS) harness adapted for wearing on the existing outerwear of a worker operating at over 6 feet above ground, said harness including:
a panel with a plurality of rope holders at opposite ends,
a length of soft, small diameter line that extends back-and-forth between the opposite ends of the panel, a free end of that line adapted for anchoring to a fixture for the worker to effect a gradual descent in the event of an emergency; and
a grommet strap in the left shoulder of the harness in which is stored a brake pin guide, a shortened brake pin and a cross brake strap that applies frictional pressure to the line from different directions at the same time and further prevents line twisting during descent.

2. The industrial EDS harness of claim 1 wherein the line is less than ¼″ in diameter.

3. The industrial EDS harness of claim 1 wherein the line is fireproof.

4. The industrial EDS harness of claim 1 wherein the line consists of Aramid® fiber.

5. The industrial EDS harness of claim 1, which includes a delta cross brake having a left arm that is longer than its right arm.

6. The industrial EDS harness of claim 5, which includes one or more strap components made from Kevlar®.

7. The industrial EDS harness of claim 1 which can be incorporated into the uniform of a worker operating at over 6 feet above ground.

8. The industrial EDS harness of claim 1 which is suitable for high elevation work by a contractor or utility serviceman.

9. The industrial EDS harness of claim 1 which includes at least about 40 feet small diameter line.

10. The industrial EDS harness of claim 9, which includes at least 100 feet of line.

11. The industrial EDS harness of claim 9, wherein said line is stored in an external delivery bag until needed.

12. The industrial EDS harness of claim 1, which can be used to safely lower a worker weighing up to 375 lbs.

13. An industrial emergency descent system comprises a harness with:
an adjustable belt that extends around a wearer's upper chest;
an adjustable belt that extends around the wearer's waist;
a pair of adjustable straps for wrapping about the wearer's upper thighs;
a pair of shoulder straps extending from said waist belt over the wearer's shoulders and criss-crossing on the wearer's back, at least one of said shoulder straps having a compartment in which a brake release pin and a cross brake strap are stored;
said shoulder straps defining a triangular back panel with a plurality of elastic loops extending along the angled side legs of said back panel;
an elongated section of small diameter line for winding from side-to-side and from top to bottom, said elongated line held within the elastic loops of said back panel;
a connector for attaching said elongated line to an elevated structure;
a rack having a plurality of apertures through which said elongated line is threaded in a predetermined pattern; and
a cover for said back panel.

14. The industrial EDS harness of claim 13 wherein the cross brake strap applies frictional pressure to the line from different directions at the same time and prevents line twisting during descent.

15. The industrial EDS harness of claim 13 wherein the line is less than ¼″ in diameter.

16. The industrial EDS harness of claim 13 wherein the line consists of Aramid® fiber.

17. The industrial EDS harness of claim 13 wherein the cross brake strap has a left arm that is longer than its right arm.

18. The industrial EDS harness of claim 13 wherein the cross brake strap includes one or more components made from Kevlar®.

19. The industrial EDS harness of claim 13 which includes at least about 40 feet small diameter line.

20. The industrial EDS harness of claim 19, which includes at least 100 feet of line.
